(19) United States
(12) Patent Application Publication
(10) Pub. No.: US 2023/0182394 A1
(43) Pub. Date: Jun. 15, 2023

(54) TOOL STATION WITH CLEANING ATTACHMENTS

(71) Applicant: HEWLETT-PACKARD DEVELOPMENT COMPANY, L.P., Spring, TX (US)

(72) Inventors: Jorge Diosdado Borrego, Sant Cugat del Valles (ES); Blanca De Prada Moriones, Sant Cugat del Valles (ES); David Chanclon Fernandez, Sant Cugat del Valles (ES)

(21) Appl. No.: 17/926,056

(22) PCT Filed: Oct. 14, 2020
(86) PCT No.: PCT/US2020/055478

§ 371 Date: Nov. 17, 2022

(51) Int. Cl. B29C 64/35; B08B 5/02; B08B 13/00; B22F 10/68; B33Y 40/20; B33Y 50/02; B29C 64/393; B22F 10/85; B33Y 30/00; G06T 7/00

(52) U.S. Cl. CPC B29C 64/35; B08B 5/02; B08B 13/00; B22F 10/68; B33Y 40/20; B33Y 50/02; B29C 64/393; B22F 10/85; B33Y 30/00; G06T 7/0004; G06T 2207/10028; G06T 2207/30168

(57) ABSTRACT

An apparatus for cleaning a set of 3D printed objects comprises a platform to receive a 3D printed object with build material attached thereto to be cleaned, a tool station to host a plurality of different cleaning attachments and a cleaning body moveable over the platform and to the tool station. The cleaning body comprises an end to receive one of the cleaning attachments. A controller is to receive data corresponding to the geometry of a portion of a 3D printed object and select, based on the received data, a cleaning attachment to clean the 3D printed object portion. The controller is further to control the cleaning body to attach the selected cleaning attachment to the cleaning body, and control the cleaning body to move to a position based on the received data and control a gas flow through the cleaning body to clean the 3D printed object portion.

### BACKGROUND

Some additive manufacturing or three-dimensional printing systems generate 3D objects by selectively solidifying portions of successively formed layers of build material on a layer-by-layer basis. The build material which has not been solidified is separated from the 3D objects to continue with the additive manufacturing process.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of an apparatus comprising a tool station with cleaning attachments;

FIG. 2 is a flowchart of an example method of controlling an apparatus with a tool station with cleaning attachments;

FIG. 3 is a schematic diagram showing an example of another apparatus comprising a tool station with cleaning attachments;

FIG. 4 is a flowchart of an example method of controlling a cleaning body and a gas flow to clean a 3D printed object;

FIG. 5 is an illustration of an example of a cross-section of a point-cloud image; and

FIG. 6 is a flowchart of an example method of modifying a point-cloud image based on a determination.

### DETAILED DESCRIPTION

The following description is directed to various examples of additive manufacturing, or three-dimensional printing, apparatus and processes involved in the generation of 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As used herein, the term “about” is used to provide flexibility to a range endpoint by providing that a given value may be, for example, an additional 15% more or an additional 15% less than the endpoints of the range. In another example, the range endpoint may be an additional 30% more or an additional 30% less than the endpoints of the range. The degree of flexibility of this term can be dictated by the particular variable and would be within the knowledge of those skilled in the art to determine based on experience and the associated description herein.

For simplicity, it is to be understood that in the present disclosure, elements with the same reference numerals in different figures may be structurally the same and may perform the same functionality.

3D printers generate 3D objects based on data in a 3D virtual model of an object or objects to be generated, for example, using a CAD computer program product. 3D printers may generate 3D objects by selectively processing layers of build material. For example, a 3D printer may selectively treat portions of a layer of build material, e.g. a powder, corresponding to a layer of a 3D object to be generated, thereby leaving the portions of the layer un-treated in the areas where no 3D object is to be generated. The combination of the generated 3D objects and the un-treated build material may also be referred to as a build volume. The enclosure in which the build bed is generated may be referred to as a build chamber.

3D printers may selectively treat portions of a layer of build material by, for example, ejecting a printing liquid in a pattern corresponding to the 3D object. Examples of printing liquids may include fusing agents, detailing agents, curable binder agents or any printing liquid suitable for the generation of a 3D object. Additionally, the chemical composition of some printing liquids may include, for example, a liquid vehicle and/or solvent to be at least partially evaporated once the printing liquid have been applied to the build material layer. For simplicity, the liquid vehicle and/or solvents may be referred hereinafter as solvents.

Some three-dimensional printing systems use fusing agents to treat the portions of the layer of build material. The portions in which the fusing agent is applied are further heated so that the fusing agent absorbs such energy to heat up and melt, coalesce and solidify upon cooling the portions of build material in which the fusing agent was ejected thereto. Some three-dimensional printing systems may heat the build material by applying energy from an energy source to each layer of build material.

Some three-dimensional printing systems use a thermally curable binder agent which has to be heated to a predetermined temperature to cause components of the liquid binder agent to bind together particles of build material on which it is applied. Such a liquid binder agent may comprise latex particles and curing of the binder may occur, for example, at a temperature above 40 degrees Celsius, above 70 degrees Celsius, above 100 degrees Celsius, or above 120 degrees Celsius, or above 150 degrees Celsius.

Such binder agents may be applied to successive layers of powdered metal build material, such as powdered stainless steel (e.g. SS316L) build material, and the curing of the binder agent leads to the generation of so-called “green parts”. Green parts are generally relatively low-density objects formed by a matrix of metal build material particles and cured binder. Green parts are transformed into highly dense final objects by heating them in a sintering furnace or oven to a temperature close to the melting point of the build material used.

After the completion of the green part generation, the build volume comprises a set of weakly bound green parts surrounded by unbound build material. Before the green parts may be moved to the sintering oven, the unbound build material is separated from the green parts.

Regardless of the 3D printing technology used, the generated 3D objects are surrounded by some agglomerated build material (e.g., partially fused, or partially bound), which is in turn surrounded by generally free-flowing build material. In some examples, vibration and air-blowing techniques may be used to separate the agglomerated and free-flowing build material from the 3D objects.

Some 3D printed parts may have geometries with features that complicate the unbound build material extraction process. Such features may include, for example, small features, cavities, and holes.

Suitable powder-based build materials for use in additive manufacturing include polymer powder, metal powder or ceramic powder. In some examples, non-powdered build materials may be used such as gels, pastes, and slurries.

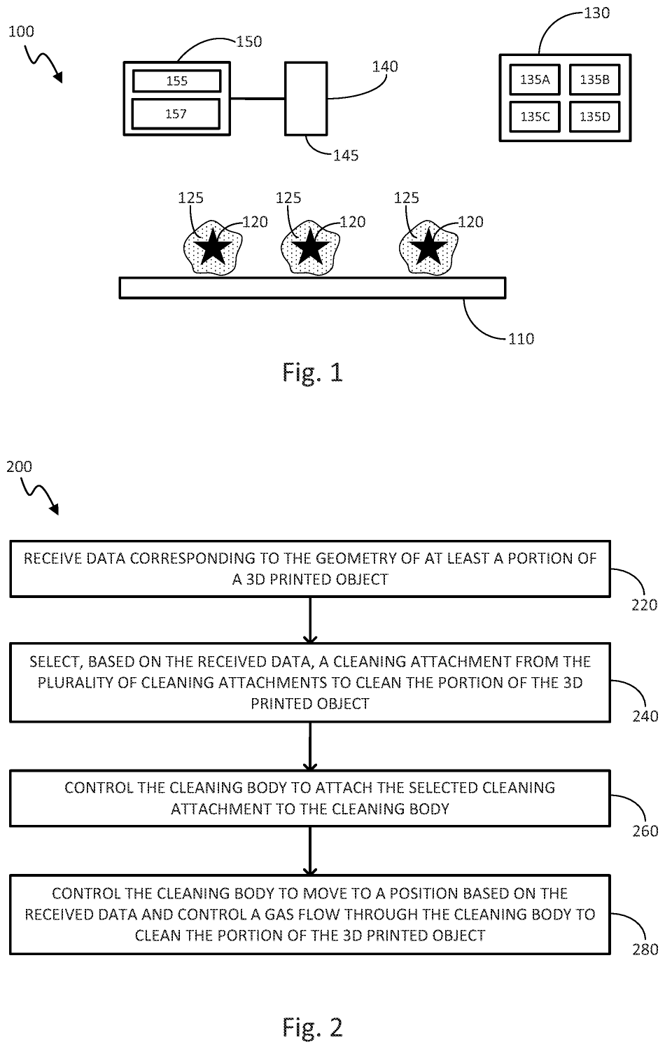

Referring now to the drawings, FIG. 1 is a schematic diagram showing an example of an apparatus 100 for cleaning a 3D object 120. In an example, the apparatus 100 is part of a 3D printer. In another example, apparatus 100 is part of a cleaning station that is external from the 3D printer. In some examples, the apparatus 100 is external to but connected through a conveying system (e.g., conveyor belt system) to a 3D printer.

The apparatus 100 comprises a platform 110. In some examples, the platform 110 is a vertically moveable platform in which build material layers are generated thereon. A 3D printer may comprise build material treating means to selectively treat portions of the build material layers to generate the 3D printed objects 120 according to the examples disclosed above. In other examples, however, the platform 110 moves horizontally or may be conveyed in a substantially horizontal direction from, for example, a 3D printer to the apparatus 100. In yet other examples, the platform 110 is a static platform. The platform 110 is to receive and hold a set of 3D printed objects 120 with build material 125 attached thereto. In the present disclosure, the term cleaning should be interpreted as removing or detaching the build material 125 from the 3D printed objects 120. In some examples, the 3D printed objects 120 are generated on the platform 120, which may be an integral part of a 3D printer. In other examples, the 3D printed objects 120 with the build material attached thereto 125 are transferred from a build chamber within the 3D printer to the platform 120. In some examples, the 3D printed objects 120 are green parts.

In some examples, the 3D printed objects 120 to be received on the platform 110 may comprise build material in which an un-cured thermally curable binder agent has been applied in a 3D printer to define the 3D objects 120. In some examples, the binder is cured after the 3D printed objects 120 generation. In other examples, the binder is cured in a layer-by-layer basis as the 3D printed objects 120 re being generated.

The apparatus 100 comprises a tool station 130 to host a plurality of cleaning attachments 135A-D. The cleaning attachments 135A-D may be outlets with an interface that is connectable to the body of a cleaning tool. The cleaning attachments 135A-D may each have different shapes and geometries and comprise an internal pathway in which a gas can flow therethrough. The cleaning attachments 135A-D may be used to clean different parts of the 3D printed objects 120. Different cleaning attachments 135A-D may remove the build material 125 more effectively than others in certain geometries of the 3D printed objects 120. In the example, four cleaning attachments 135A-D have been illustrated, however it is to be understood that any other amount of cleaning attachments may have been used without departing from the scope of the present disclosure, for example two or six cleaning attachments.

In an example, one of the cleaning attachments 135A-D may include a cylindrical jet nozzle. The cross-section of the cylindrical jet nozzle may be circular or substantially circular (e.g., elliptical). A cylindrical jet nozzle may effectively remove build material 125 located in single directional pass-through cavities from a 3D printed object 120.

In another example, the one of the cleaning attachments 135A-D may include an air knife. In the present disclosure, an air knife may be implemented as a pressurized air plenum containing a series of holes (e.g., nozzles) or a slot through which pressurized air exits in a laminar flow pattern to remove build material 135 from 3D printed objects 130 as the air knife moves relative to the 3D objects 120. An air knife may effectively remove build material 125 attached to elongated 3D printed objects 120.

In another example, one of the cleaning attachments 135A-D may include a multi-nozzle attachment with a plurality of nozzles oriented in multiple directions, for example, a perforated spherical cleaning attachment, or a conical-shaped cleaning attachment. In the example of a perforated spherical cleaning attachment, the plurality of nozzles corresponding to the perforations may blow an airflow radially. In the example of a conical-shaped cleaning attachment, the conical surface of the cleaning attachment may comprise a plurality of nozzles (or perforations), a set of which may blow an airflow in a direction substantially perpendicular from the surface where the nozzle is located at.

In yet another example, one of the cleaning attachments 135A-D may include a custom 3D printed shaped attachment. The 3D printed shaped attachment may be previously generated through an additive manufacturing process. The custom 3D printed shaped attachment may comprise a shape suitable for an effective removal of build material 125 from the 3D printed objects 120. For example, the custom 3D printed shaped attachment may have a shape based on the top surface of a set of the 3D printed objects 120. In another example, the custom 3D printed shaped attachment may have a shape based on the top surface and a lateral surface of a set of 3D printed objects 120. In some examples, the custom 3D printed shaped attachment may have a shape corresponding to the negative shape of the top and/or lateral surface of a set of 3D printed objects 120. In yet other examples, the custom 3D printed shaped attachment may have a shape corresponding to an internal feature of the 3D printed object 120.

The apparatus 100 further comprises a cleaning body 140 moveable over the platform 110 and to the tool station 130. In an example, the cleaning body 140 may move in the Cartesian axis. In another example, the cleaning body 140 may additionally rotate. The cleaning body 140 comprises an end 145 with an interface to receive one of the plurality of cleaning attachments 135A-D from the tool station 130. In some examples, the cleaning body 140 may move to the tool station and attach to a cleaning attachment and then move to the 3D printed objects 120 and remove the build material 135. In some examples, the cleaning body 140 is fluidically connectable to a gas flow source (not shown). In some examples, the gas flow source may be part of the apparatus 100. In other examples, however, the gas flow source may be external from the apparatus 100 and connectable to the cleaning body 140. In some examples, the gas flow is an air flow. In other examples, the gas from the gas flow may be another gas, such as nitrogen.

Additionally, in some examples, the apparatus 100 may further comprise a controllable vibration element (e.g., vibration plate, eccentric motor) controllably coupled to a controller 150 that causes the vibration element to vibrate. The vibration causes the fluidization of the build material 135 which can be directed to an external reservoir and thereby be extracted from the apparatus 100. The fluidized build material 130 may be directed to the external reservoir by means of, for example, a drain, an airflow or a sieve. In some examples, a controller may control the vibration element to vibrate at very high frequencies (e.g., ultrasounds) for example at 20 kHz, and at low amplitudes, for example of 20 microns. Vibrating at high frequencies and low amplitudes enables to successfully remove build material 135 whilst avoid damage to the fragile 3D objects 130. However, the controller may control the vibration element to vibrate at lower frequencies, for example 35 Hz, and higher amplitudes, for example 1 mm.

The apparatus 100 further comprises a controller 150. The controller comprises a processor 155 and a memory 157 with specific control instructions stored therein to be executed by the processor 155. The controller may be controllably coupled to the cleaning body 140, the gas flow generator, and/or the vibration element. The controller may control at least some of the operations of the elements that it is coupled therewith. The functionality of the controller is described further below with reference to FIGS. 2, 4 and 6.

In the examples herein, the controller may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller may be, at least partially, implemented in the form of an electronic circuitry. The controller may be a distributed controller, a plurality of controllers, and the like.

FIG. 2 is a flowchart of an example method 200 of controlling the apparatus 100 with a tool station 130 with cleaning attachments 135A-D. The method 200 may involve previously disclosed elements from FIG. 1 referred to with the same reference numerals. In some examples, parts of method 200 may be executed by the controller 150 of the apparatus 100.

At block 220, the controller 150 may receive data corresponding to the geometry of at least a portion of a 3D printed object 120. The data may be indicative of special features of the geometry of the portion of the 3D printed object 120. In an example, the data may include that the geometry of the portion of the 3D printed object 120 comprises a feature which is substantially smaller than the other portions of the 3D printed object (e.g., less than 1 cm length feature), an elongated cavity with respect to a Cartesian axis (e.g., vertical axis), an inner volume corresponding to a bottle or vessel, and the like.

At block 240, the controller 150 may select, based on the received data, a cleaning attachment from the plurality of cleaning attachments 135A-D to clean the portion of the 3D printed object 120. For example, if the data is indicative that the portion of the 3D printed object 120 comprises an elongated cavity with respect to a Cartesian axis, the controller 150 may select a cylindrical jet nozzle cleaning attachment of an appropriate size. In another example, if the data is indicative that the portion of the 3D printed object 120 comprises an elongated feature with respect to a Cartesian axis, the controller 150 may select an air knife cleaning attachment. In another example, if the data is indicative that the portion of the 3D printed object 120 comprises an inner volume of a bottle or vessel feature, the controller 150 may select a multi-nozzle attachment with a plurality of nozzles oriented in multiple directions, such as a perforated spherical cleaning attachment. In yet another example, if the data is indicative that the portion of the 3D printed object 120 comprises an outer volume of a bottleneck shaped or bar-shaped feature, the controller 150 may select a multi-nozzle attachment with a plurality of nozzles oriented in multiple directions, such as a conical-shaped cleaning attachment.

At block 260, the controller 150 may control the cleaning body 140 to attach the selected cleaning attachment to the cleaning body 140 through, for example, the end 145 of the cleaning attachment with a corresponding attaching interface from the selected cleaning attachment.

At block 280, the controller 150 may control the cleaning body 140 to move to a position based on the received data and control a gas flow through the cleaning body 140 to clean the portion of the 3D printed object 120. In an example, the controller 150 is to control the pressure at the portion of the 3D printed object 120 by controlling the position of the cleaning body 140, and thereby the attached cleaning attachment, with respect to the portion of the 3D object 120 to be cleaned. Fragile 3D printed objects 120 (e.g., green parts) may be subject to breakage if a gas flow having an excessive pressure is applied thereto. Additionally, or alternatively, the controller 150 is to control the gas flow pressure. In these examples, the controller 150 may control the position of the cleaning body 140 and/or the airflow pressure based on, for example, the type of cleaning attachment which has been selected and attached and/or the distance between the attached cleaning attachment in a cleaning position.

As mentioned above, in some examples, the controller 150 may control the pressure at the portion of the 3D printed object 120 by controlling the position of the cleaning body 140 with respect to the portion of the 3D object 120 to be cleaned. In some of these examples, the controller 150 is to control the position of the cleaning body 140 such that the selected and attached cleaning attachment is at a distance with respect to the 3D printed object 120 of less than about 50 mm; for example, at about 1, 5, 10, 20, 30, 40 or 50 mm. Additionally, the controller 150 is to control the position of the cleaning body 140 such that, when in use, the selected and attached cleaning attachment is not physically in contact with any portion of the 3D printed object 120, including the portion which is intended to be cleaned.

As mentioned above, in some examples, the controller 150 may control the pressure at the portion of the 3D printed object 120 by controlling the gas flow pressure in the cleaning body 140. In an example, the controller 150 may control a gas flow element, such as a valve, fluidically connected between the gas flow source and the cleaning body 140 to open, close, partially open, or partially close to control the pressure of the gas flow pressure in the cleaning body 140, and thereby, to the portion of the 3D printed object 120. In another example, the controller 150 may control another gas flow element, such as the gas flow generator, to control the pressure of the gas flow pressure in the cleaning body 140. In the above examples, the controller may control the pressure in the cleaning body 140 to be less than about 10 bar; for example, about 2, 4, 6, 8 or 10 bar.

Additionally, in some examples, the controller 150 may control the cleaning body 140 to move from a first position to a second position based on the geometry of the 3D printed object 120 to clean the portion of the 3D printed object 120. In an example, the controller 150 may determine the pathway that the cleaning body 140 follows based on the orientation of the 3D printed object to avoid any potential collision between the cleaning body 140 or the attached cleaning attachment with the 3D printed object 120 which may lead to the breakage of the 3D printed object 120.

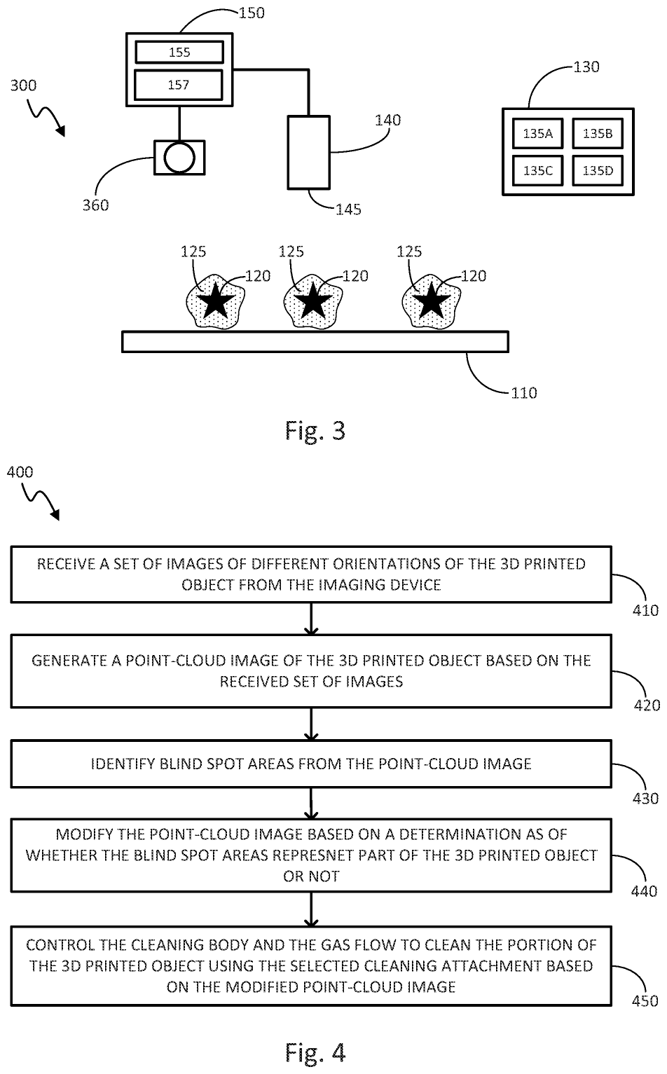

FIG. 3 is a schematic diagram showing an example apparatus 300 comprising a tool station 130 with cleaning attachments 130A-D. The apparatus 300 may involve previously disclosed elements from the apparatus 100 of FIG. 1 referred to with the same reference numerals. The apparatus 300 comprises the platform 110, the tool station 130 to host a plurality of different cleaning attachments 135A-D, the cleaning body 140 and the controller 150. The controller 150 may additionally perform the functionality described further below with reference to FIG. 4.

The apparatus 300 further comprises an imaging device 360 located above the platform 110. The imaging device 360 may be a camera, a camcorder, a motion picture camera, or any other instrument, equipment or format capable of recording, storing, or transmitting visual images. In some examples, the imaging device 360 is a moveable imaging device 360 being able to record images of the 3D printed objects 120 and build material 125 from different angles. In other examples, the apparatus 300 comprises a plurality of static imaging devices 360 located at different positions above the platform to record images of the 3D printed objects 120 and build material 125 from different angles. The imaging device 360 is controllable by the controller 150.

FIG. 4 is a flowchart of an example method 400 of controlling the cleaning body 140 and a gas flow to clean a 3D printed object 120 from the attached build material 125. The method 400 may involve previously disclosed elements from FIG. 3 referred to with the same reference numerals. In some examples, parts of method 400 may be executed by the controller 150 of the apparatus 300. In some examples, the controller 150 may execute method 400 in parallel with blocks 240 and/or 260 from method 200 of FIG. 2. In other examples, the controller 150 may execute method 400 sequentially after any of blocks 220, 240, or 260 from method 200 from FIG. 2.

At block 410, the controller 150 may receive a set of images of the 3D printed object 120 from the imaging device 360. The set of images may correspond to images of the 3D printed object 120 from different angles, thereby being images of different orientations of the 3D printed object 120. In an example, the controller 150 may have previously requested the set of images to the imaging device 360. In other examples, the imaging device 360 sends the set of images in a periodic basis.

At block 420, the controller 150 may generate a point-cloud image of the 3D printed object 120 based on the received set of images. A point-cloud image is a set of data points in space indicative of an external surface object. In the examples herein, the point-cloud image is indicative of the external surface of the 3D generated object 120 and the build material 125 attached thereto.

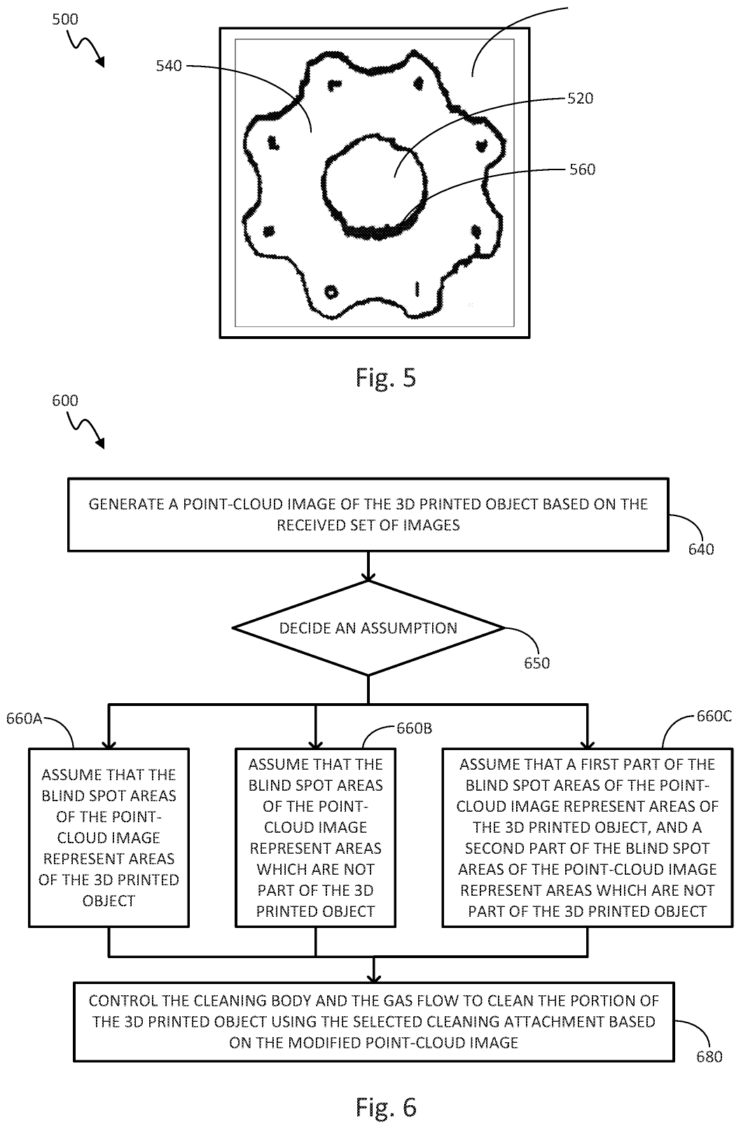

FIG. 5 is an illustration of an example of a cross-section of a point-cloud image 500. The point-cloud image 500 comprises different portions or areas. Area 520 from the point-cloud image 500 does not comprise any point, thereby being indicative that there is no 3D printed object 120 or build material 125 in the area 520. However, area 540 from the point-cloud image 500 comprises points, thereby being indicative that there is wither 3D printed object 120 of build material 125 to be cleaned in the area 540.

The controller 150 may not generate a full point-cloud image of the 3D printed object 120 based on the received images. Depending on the number of images and the orientation of the received set of images, the controller 150 may have a more complete view of the 3D printed object 120 and the build material 125 on the platform 110 and thereby some areas from the point-cloud image 500, referred hereinafter as blind spot areas 560, may not be included in the point-cloud image data. The real contents of the blind spot areas 560 are unknown by the controller 150, which may include parts of the 3D printed object 120, build material 125, or neither 3D printed object 120 not build material 125 (e.g., air).

In different examples, the controller 150 may encode the areas 520-560 in different ways. For example, the controller 150 may encode areas 520 with code “0”, areas 540 with code “1”, and the areas 560 with code “no data”. Other encoding examples may be used without departing from the scope of the present disclosure.

Turning back to FIG. 4, at block 430, the controller 150 identifies the blind spot areas 560 from the point-cloud image. In an example, the controller 150 may identify the blind spot areas by searching the corresponding code in the point-cloud image (e.g., “no data” in the example of FIG. 5).

At block 440, the controller 150 modifies the point-cloud image based on a determination as to whether the blind spot areas represent part of the 3D printed object or not. In some examples, the controller 150, based on the determination (see, e.g., examples in FIG. 6), may modify the point-cloud image areas identified as blind spot areas 560 to identify them as object areas 540, thereby the modification being indicative that blind spot areas 560 include a part of a 3D printed object 120 or build material 125. In other examples, the controller 150, based on the determination, may modify the point-cloud image blind spot areas 560 to not include points identified as areas 520, the modification being indicative that blind spot areas 560 do not include a part of a 3D printed object 120 nor build material 125. In yet other examples, the controller 150, based on the determination, may modify some of the point-cloud image blind spot areas 560 to include points identified as areas 540 and the other blind spot areas 560 to not include points as in areas 520. Some examples of the determination may be found in the description below with reference to FIG. 6.

At block 450, the controller 150 controls the cleaning body 140 and the gas flow to clean the portion of the 3D printed object using the selected cleaning attachment based on the modified point-cloud image. The cleaning operation executed in block 450 may be similar to the corresponding operation in block 280 from FIG. 2, with the addition that the operation is further based on the modified point-cloud image.

FIG. 6 is a flowchart of an example method 600 of modifying a point-cloud image. The method 600 may involve previously disclosed elements referred to with the same reference numerals. In some examples, parts of method 600 may be executed by the controller 150 of the apparatus 300.

At block 640, the controller 150 generates a point-cloud image (e.g., point-cloud image 500 from FIG. 5) of the 3D printed objects 120 based on the received set of images. Block 640 may be the same as or similar to block 420 from FIG. 4. Following block 640, the controller 150 may execute one of blocks 660A-C.

At decision block 650, the controller 150 decides which assumption to be made in order to modify the point-cloud image. The decision of which assumption to be made may be input by the user or previously encoded in the controller 150.

In another example, the assumption is that the blind spot area 560 of the point-cloud image represents areas of the 3D printed object 120 or build material 125. In yet another example, the assumption is that the blind spot area 560 of the point-cloud image represent areas which are not part of the 3D printed object 120 or build material 125. In yet another example, the assumption is that the a first part of the blind spot area 560 represent an area of the 3D printed object 120 or build material 125 and a second part of the blind spot area 560 represent an area which is not part of the 3D printed object 120 nor build material 125.

At block 660A, the controller 150 modifies the point-cloud image by assuming that a blind spot area 560 (or a plurality of blind spot areas 560) of the point-cloud image represents areas of the 3D printed object 120 or build material 125 (e.g., areas 540 from FIG. 5). This assumption lowers the risk of collision of the cleaning body 140 or the attached cleaning attachment with the 3D printed object 120, and thereby reducing the risk of breakage of the 3D printed object during the cleaning operation. However, in the event that the real volume corresponding to the blind spot area 560 do not contain any part of the 3D printed object 120 or build material 125, the cleaning throughput may be reduced since the distance between the cleaning attachment and the build material 125 to be cleaned may be larger than is ideal.

At block 660B, the controller 150 modifies the point-cloud image by assuming that a blind spot area 560 (or a plurality of blind spot areas 560) of the point-cloud image represent areas which are not part of the 3D printed object 120 or build material 125 (e.g., areas 520 from FIG. 5). This assumption enhances the cleaning throughput since the cleaning attachment may be at the designed distance from the part of the 3D printed object 120 or build material 125. However, in the event that the real volume corresponding to the blind spot area 560 contains a part of the 3D printed object 120 or build material 125, there is risk of collision between the cleaning body 140 or the attached cleaning attachment with the 3D printed object 120, which may lead to the breakage of the 3D printed object 120.

At block 660C, the controller 150 modifies the point-cloud image by assuming that a first part of the blind spot area 560 represent an area of the 3D printed object 120 or build material 125 (e.g., area 540 from FIG. 5), and a second part of the blind spot area 560 represent an area which is not part of the 3D printed object 120 nor build material 125 (e.g., area 520 from FIG. 5). In some examples, the controller 150 is to define the first and second parts of the blind spot area 560 based on a geometry of a 3D object model corresponding to the 3D printed object 120. In other examples, the controller 150 is to define the first and second parts of the blind spot area 560 based on the vertical position within the point-cloud image. For example, the lower portion of the blind spot area 560 to represent an area of the 3D printed object 120 or build material 125, and the higher portion of the blind spot area 560 to represent an area which is not part of the 3D printed object 120 or build material 125.

At block 680, the controller 150 may control the cleaning body 140 and the gas flow to clean the portion of the 3D printed object 120 using the selected cleaning attachment based on the modified point-cloud image. Block 680 may be the same as or similar to block 450 from FIG. 4.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: An apparatus for cleaning a 3D printed object, the apparatus comprising:

a platform to receive a 3D printed object with build material attached thereto to be cleaned;

a tool station to host a plurality of different cleaning attachments;

a cleaning body moveable over the platform and to the tool station, the cleaning body comprising an end to receive one of the plurality of cleaning attachments; and

a controller to:
receive data corresponding to the geometry of at least a portion of a 3D printed object;
select, based on the received data, a cleaning attachment from the plurality of cleaning attachments to clean the portion of the 3D printed object;
control the cleaning body to attach the selected cleaning attachment to the cleaning body; and
control the cleaning body to move to a position based on the received data and control a gas flow through the cleaning body to clean the portion of the 3D printed object.

Feature set 2: An apparatus with feature set 1, wherein the tool station comprises a plurality of cleaning attachments including at least one of a cylindrical jet nozzle, an air knife, a multi-nozzle attachment with a plurality of nozzles oriented in multiple directions, and/or a custom 3D printed shaped attachment.

Feature set 3: An apparatus with any preceding feature set 1 to 2, wherein the controller is to control the pressure at the portion of the 3D object to be cleaned by controlling the position of the cleaning body with respect to the portion of the 3D object to be cleaned and/or the gas flow pressure.

Feature set 4: An apparatus with any preceding feature set 1 to 3, further comprising an imaging device, and wherein the controller is further to: (i) receive a set of images of different orientations of the 3D printed object from the imaging device; (ii) generate a point-cloud image of the 3D printed object based on the received set of images; (iii) identify blind spot areas from the point-cloud image; (iv) modify the point-cloud image based on a determination as of whether the blind spot areas represent part of the 3D printed object or not; and (v) control the cleaning body and the gas flow to clean the portion of the 3D printed object using the selected cleaning attachment based on the modified point-cloud image.

Feature set 5: An apparatus with any preceding feature set 1 to 4, wherein the controller is further to control the cleaning body to move from a first position to a second position based on the geometry of the 3D printed object to clean the portion of the 3D printed object.

Feature set 6: An apparatus with any preceding feature set 1 to 5, wherein the controller is to modify the point-cloud image by assuming that the blind spot area of the point-cloud image represents areas of the 3D printed object.

Feature set 7: An apparatus with any preceding feature set 1 to 6, wherein the controller is to modify the point-cloud image by assuming that the blind spot area of the point-cloud image represents areas which are not part of the 3D printed object.

Feature set 8: An apparatus with any preceding feature set 1 to 7, wherein the controller is to modify the point-cloud image by assuming that: a first part of the blind spot area represent an area of the 3D printed object, and second part of the blind spot area represent an area which is not part of the 3D object.

Feature set 9: An apparatus with any preceding feature set 1 to 8, wherein the controller is to define the first and second parts of the blind spot area based on a geometry of a 3D object model corresponding to the 3D printed object.

Feature set 10: An apparatus with any preceding feature set 1 to 9, wherein the controller is to define the first and second parts of the blind spot area based on the vertical position within the point-cloud image.

Feature set 11: An apparatus with any preceding feature set 1 to 10, wherein the controller is to control the cleaning body and the gas flow to clean the portion of the 3D printed object using the selected cleaning attachment at a distance, with respect to the 3D printed object, less than about 50 mm.

Feature set 12: An apparatus with any preceding feature set 1 to 11, wherein the controller is to control a gas flow element fluidically connected to the cleaning body to generate a gas flow pressure in the cleaning body of less than about 10 bar.

Feature set 13: A method to clean a portion of a physical 3D printed object, the method comprising:

selecting, based on a virtual 3D object model associated with the physical 3D printed object, a cleaning attachment from a plurality of cleaning attachments within a tool station, to clean at least a portion of the 3D printed object;

attaching the selected cleaning attachment to the cleaning body; and

moving the cleaning body to a position based on the virtual 3D object model and controlling a gas flow through the cleaning body to clean the portion of the 3D printed object.

Feature set 14: A method with feature set 13, wherein the cleaning attachment is one of a cylindrical jet nozzle, an airknife, a multi-nozzle attachment with a plurality of nozzles oriented in multiple directions, and/or a custom 3D printed shaped attachment.

Feature set 15: A 3D printer comprising:

a build platform in which layers of build material are generated thereon;

build material treating means to treat portions of a layer of build material to generate a 3D printed object;

a tool station to host a plurality of different cleaning attachments;

a cleaning body moveable over the platform and to the tool station, the cleaning body comprising an end to receive one of the plurality of cleaning attachments; and

a controller to:
receive data corresponding to the geometry of at least a portion of a 3D printed object;
control the build material treating means to generate a 3D object on the build platform based on the received data;
select, based on the received data, a cleaning attachment from the plurality of cleaning attachments to clean at least the portion of the 3D printed object;
control the cleaning body to attach the selected cleaning attachment to the cleaning body; and
control the cleaning body to move to a position based on the received data and control a gas flow through the cleaning body to clean the portion of the 3D printed object.

What it is claimed is:

1. An apparatus for cleaning a 3D printed object, the apparatus comprising:
a platform to receive a 3D printed object with build material attached thereto to be cleaned;
a tool station to host a plurality of different cleaning attachments;
a cleaning body moveable over the platform and to the tool station, the cleaning body comprising an end to receive one of the plurality of cleaning attachments; and
a controller to:
receive data corresponding to the geometry of at least a portion of a 3D printed object;
select, based on the received data, a cleaning attachment from the plurality of cleaning attachments to clean the portion of the 3D printed object;
control the cleaning body to attach the selected cleaning attachment to the cleaning body; and
control the cleaning body to move to a position based on the received data and control a gas flow through the cleaning body to clean the portion of the 3D printed object.

2. The apparatus of claim 1, wherein the tool station comprises a plurality of cleaning attachments including at least one of a cylindrical jet nozzle, an air knife, a multi-nozzle attachment with a plurality of nozzles oriented in multiple directions, and/or a custom 3D printed shaped attachment.

3. The apparatus of claim 1, wherein the controller is to control the pressure at the portion of the 3D object to be cleaned by controlling the position of the cleaning body with respect to the portion of the 3D object to be cleaned and/or the gas flow pressure.

4. The apparatus of claim 1, further comprising an imaging device, and wherein the controller is further to:
receive a set of images of different orientations of the 3D printed object from the imaging device;
generate a point-cloud image of the 3D printed object based on the received set of images;
identify blind spot areas from the point-cloud image;
modify the point-cloud image based on a determination as of whether the blind spot areas represent part of the 3D printed object or not; and
control the cleaning body and the gas flow to clean the portion of the 3D printed object using the selected cleaning attachment based on the modified point-cloud image.

5. The apparatus of claim 4, wherein the controller is further to control the cleaning body to move from a first position to a second position based on the geometry of the 3D printed object to clean the portion of the 3D printed object.

6. The apparatus of claim 4, wherein the controller is to modify the point-cloud image by assuming that the blind spot area of the point-cloud image represents areas of the 3D printed object.

7. The apparatus of claim 4, wherein the controller is to modify the point-cloud image by assuming that the blind spot area of the point-cloud image represents areas which are not part of the 3D printed object.

8. The apparatus of claim 4, wherein the controller is to modify the point-cloud image by assuming that:
a first part of the blind spot area represents an area of the 3D printed object, and
a second part of the blind spot area represent an area which is not part of the 3D object.

9. The apparatus of claim 8, wherein the controller is to define the first and second parts of the blind spot area based on a geometry of a 3D object model corresponding to the 3D printed object.

10. The apparatus of claim 8, wherein the controller is to define the first and second parts of the blind spot area based on the vertical position within the point-cloud image.

11. The apparatus of claim 1, wherein the controller is to control the cleaning body and the gas flow to clean the portion of the 3D printed object using the selected cleaning attachment at a distance, with respect to the 3D printed object, less than about 50 mm.

12. The apparatus of claim 1, wherein the controller is to control a gas flow element fluidically connected to the cleaning body to generate a gas flow pressure in the cleaning body of less than about 10 bar.

13. A method to clean a portion of a physical 3D printed object, the method comprising:
selecting, based on a virtual 3D object model associated with the physical 3D printed object, a cleaning attachment from a plurality of cleaning attachments within a tool station, to clean at least a portion of the 3D printed object;
attaching the selected cleaning attachment to the cleaning body; and
moving the cleaning body to a position based on the virtual 3D object model and controlling a gas flow through the cleaning body to clean the portion of the 3D printed object.

14. The method of claim 13, wherein the cleaning attachment is one of a cylindrical jet nozzle, an airknife, a multi-nozzle attachment with a plurality of nozzles oriented in multiple directions, and/or a custom 3D printed shaped attachment.

15. A 3D printer comprising:
a build platform in which layers of build material are generated thereon;
build material treating means to treat portions of a layer of build material to generate a 3D printed object;
a tool station to host a plurality of different cleaning attachments;
a cleaning body moveable over the platform and to the tool station, the cleaning body comprising an end to receive one of the plurality of cleaning attachments; and
a controller to:
receive data corresponding to the geometry of at least a portion of a 3D printed object;
control the build material treating means to generate a 3D object on the build platform based on the received data;
select, based on the received data, a cleaning attachment from the plurality of cleaning attachments to clean at least the portion of the 3D printed object;
control the cleaning body to attach the selected cleaning attachment to the cleaning body; and
control the cleaning body to move to a position based on the received data and control a gas flow through the cleaning body to clean the portion of the 3D printed object.
